(19) United States
(12) Patent Application Publication
(10) Pub. No.: US 2025/0200701 A1
(43) Pub. Date: Jun. 19, 2025

(54) METHOD AND APPARATUS WITH HIGH-RESOLUTION IMAGE RESTORATION

(71) Applicant: Samsung Electronics Co., Ltd., Suwon-si (KR)

(72) Inventors: Eunhee KANG, Suwon-si (KR); Sehwan KI, Suwon-si (KR); Younghyun JO, Suwon-si (KR); Jisoo SON, Suwon-si (KR); Hyong Euk LEE, Suwon-si (KR)

(73) Assignee: Samsung Electronics Co., Ltd., Suwon-si (KR)

(21) Appl. No.: 18/975,623

(22) Filed: Dec. 10, 2024

(30) Foreign Application Priority Data
Dec. 15, 2023 (KR) 10-2023-0182852

(51) Int. Cl. G06T 3/40; G06T 5/10; G06T 5/70; G06T 7/40; G06V 10/771

(52) U.S. Cl. CPC G06T 3/40; G06T 5/10; G06T 5/70; G06T 7/40; G06V 10/771; G06T 2207/20056

(57) ABSTRACT

A processor-implemented method with high-resolution (HR) image restoration includes mapping an input image with low resolution (LR) to a feature map of a latent domain, generating, using a diffusion model, an HR feature in which a certain frequency component corresponding to the feature map is restored, and based on the HR feature and coordinate information and pixel information of an HR image at a target magnification, restoring the HR image at the target magnification corresponding to the feature map.

### CROSS-REFERENCE TO RELATED APPLICATIONS

This application claims the benefit under 35 USC § 119 (a) of Korean Patent Application No. 10-2023-0182852, filed on Dec. 15, 2023 in the Korean Intellectual Property Office, the entire disclosure of which is incorporated herein by reference for all purposes.

### BACKGROUND

### 1. Field

The following description relates to a method and apparatus with high-resolution (HR) image restoration.

### 2. Description of Related Art

An image super-resolution (SR) technique may include a method of obtaining a high-resolution (HR) image from a low-resolution (LR) image. The image SR technique may refer to a technique for increasing the quality of an LR image to HR and may also refer to a zoom technique that enlarges a small object in an image.

Most image SR techniques applied to a smartphone camera may only restore an HR image at a fixed magnification (such as 2 times, 4 times, or 8 times), and in some cases, even if HR at a target magnification is restored, the image quality may be lower than that of the HR image at a fixed magnification.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method with high-resolution (HR) image restoration includes mapping an input image with low resolution (LR) to a feature map of a latent domain, generating, using a diffusion model, an HR feature in which a certain frequency component corresponding to the feature map is restored, and based on the HR feature and coordinate information and pixel information of an HR image at a target magnification, restoring the HR image at the target magnification corresponding to the feature map.

The mapping of the input image to the feature map of the latent domain may include mapping the input image to the feature map of the latent domain using an encoder network.

The diffusion model may be configured to perform a reverse diffusion process that gradually subtracts noise values generated by a learned normal distribution from pixel values of the feature map, and a diffusion process that gradually adds noise values according to a fixed normal distribution to the pixel values of the feature map.

The generating of the HR feature may include restoring the certain frequency component corresponding to the feature map by repeatedly performing the reverse diffusion process of the diffusion model by a predetermined number of times.

The generating of the HR feature may include generating, using the diffusion model, the HR feature in which the certain frequency component corresponding to the feature map is restored, by concatenating or adding gradually changing input noise with or to the feature map.

The generating of the HR feature may include extracting a scaling factor and a bias factor from the feature map using a normalization technique, and generating the HR feature in which the certain frequency component corresponding to the feature map is restored, by applying the scaling factor and the bias factor to the feature map.

The normalization technique may include one of a group normalization technique, an adaptive group normalization (AdaGN) technique, and an instance normalization technique.

The generating of the HR feature may include generating the HR feature in which the certain frequency component corresponding to the feature map is restored, by applying the feature map to a cross-attention technique.

The generating of the HR feature may include receiving image quality-related keywords corresponding to the input image, extracting a text feature corresponding to the image quality-related keywords, and generating the HR feature in which the certain frequency component corresponding to the feature map is restored, by mapping the text feature to the feature map.

The extracting of the text feature may include extracting the text feature corresponding to the image quality-related keywords using a text encoder based on a pre-trained vision language model (VLM).

The mapping of the input image to the feature map of the latent domain further may include estimating frequency information from the feature map, and the generating of the HR feature may include generating the HR feature in which the certain frequency component corresponding to the feature map is restored, by applying the frequency information to the diffusion model.

The estimating of the frequency information may include estimating the frequency information from the feature map using either one or both of a fast Fourier transform (FFT) technique and a local texture estimation (LTE) technique for an implicit expression function.

The restoring of the HR image may include estimating pixel values of the HR image at the target magnification comprising the HR feature, based on the HR feature, and the coordinate information and the pixel information of the HR image at the target magnification, and restoring the HR image at the target magnification by the estimated pixel values.

The estimating of the pixel values of the HR image at the target magnification may include estimating the pixel values of the HR image at the target magnification comprising the HR feature, from the HR feature, and the coordinate information and the pixel information of the HR image at the target magnification, using a decoder network.

The decoder network may include a network based on multi-layer perceptron.

In one or more general aspects, a non-transitory computer-readable storage medium may store instructions that, when executed by one or more processors, configure the one or more processors to perform any one, any combination, or all of operations and/or methods disclosed herein.

In one or more general aspects, an apparatus with high-resolution (HR) image restoration includes one or more processors configured to map, using an encoder network, an input image with low resolution (LR) to a feature map of a latent domain, generate, using a diffusion model, an HR feature in which a certain frequency component corresponding to the feature map is restored, and based on the HR feature and coordinate information and pixel information of an HR image at a target magnification, restore, using a decoder network, the HR image at the target magnification corresponding to the feature map.

For the generating of the HR feature, the one or more processors may be configured to generate, using the diffusion model, the HR feature in which the certain frequency component corresponding to the feature map is restored, by concatenating gradually changing input noise with the feature map.

The one or more processors may be configured to extract, using a text encoder based on a pre-trained vision language model (VLM), extract a text feature corresponding to image quality-related keywords corresponding to the input image, and for the generating of the HR feature, generate, using the diffusion model, the HR feature in which the certain frequency component corresponding to the feature map is restored, by mapping the text feature to the feature map.

The apparatus may be any one or any combination of any two or more of a smartphone, a camera, a closed-circuit television (CCTV), medical image equipment, semiconductor measurement equipment, an autonomous vehicle camera, a mixed reality (MR) device, and an augmented reality (AR) device.

Other features and aspects will be apparent from the following detailed description, the drawings, and the claims.

### BRIEF DESCRIPTION OF THE DRAWINGS

FIG. 1 illustrates an example of a method of restoring a high-resolution (HR) image.

FIG. 2 illustrates an example of a method of restoring an HR image.

FIGS. 3A and 3B illustrate examples of a structure and operation of a diffusion model.

FIGS. 4A and 4B illustrate examples of a process of generating an HR feature in which a certain frequency component is restored, through a reverse diffusion process of a diffusion model.

FIG. 5 illustrates an example of a method of modeling conditions to a diffusion model.

FIG. 6 illustrates an example of a method of restoring an HR image at a target magnification.

FIG. 7 illustrates an example of a method of restoring an HR image in which a certain frequency component is restored, based on a text feature.

FIG. 8 illustrates an example of a method of restoring an HR image based on estimated frequency information.

FIG. 9 illustrates an example of an apparatus for restoring an HR image.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, should be construed to have meanings matching with contextual meanings in the relevant art and the disclosure of the present application, and are not to be construed to have an ideal or excessively formal meaning unless otherwise defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Examples to be described below may be, for example, applied to various devices (e.g., a smartphone, camera, closed-circuit television (CCTV), medical image equipment, semiconductor measurement equipment, autonomous vehicle camera, mixed reality (MR) device, augmented reality (AR) device, etc.) that restore a high-resolution (HR) image at a target magnification by restoring a high-frequency component.

Hereinafter, the examples are described in detail with reference to the accompanying drawings. When describing the examples with reference to the accompanying drawings, like reference numerals refer to like elements and any repeated description related thereto is omitted.

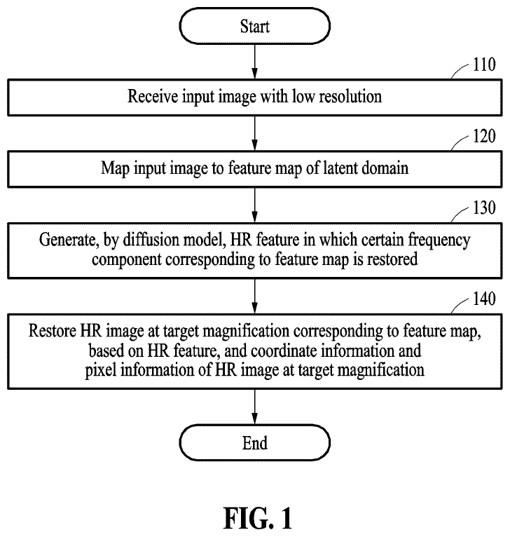

FIG. 1 illustrates an example of a method of restoring an HR image. Operations to be described with reference to FIG. 1 and below may be performed sequentially but not necessarily. For example, the order of the operations may change and at least two of the operations may be performed in parallel or one operation may be performed separately.

An apparatus with HR image restoration (hereinafter, referred to as a “restoration apparatus”) may restore an HR image through operations 110 to 140.

In operation 110, the restoration apparatus may receive an input image with low resolution (LR). The input image may include, for example, any type of LR image, such as raw data obtained from a complementary metal-oxide semiconductor (CMOS) imaging sensor (CIS) and/or an image pre-processed by an image signal processor (ISP).

In operation 120, the restoration apparatus may map the input image received from operation 110 to a feature map of a latent domain. Here, the restoration apparatus may map a feature of the input image to the latent domain in various forms such as a feature vector in addition to the feature map. The ‘latent domain’ may be, for example, a space corresponding to one or more intermediate layers of hidden layers in a deep neural network (DNN) and may be referred to as an ‘embedding space’ in that a latent vector or embedding vector is extracted from the latent domain.

The restoration apparatus may map the input image to the feature map of a latent domain using an encoder network. Here, the encoder network may include, for example, any one or more of a convolutional neural network (CNN) among a ResNet-based enhanced deep residual network (EDSR), residual dense network (RDN), and/or image restoration using Swin transformer (SwinIR) network with a transformer structure, but is not necessarily limited thereto.

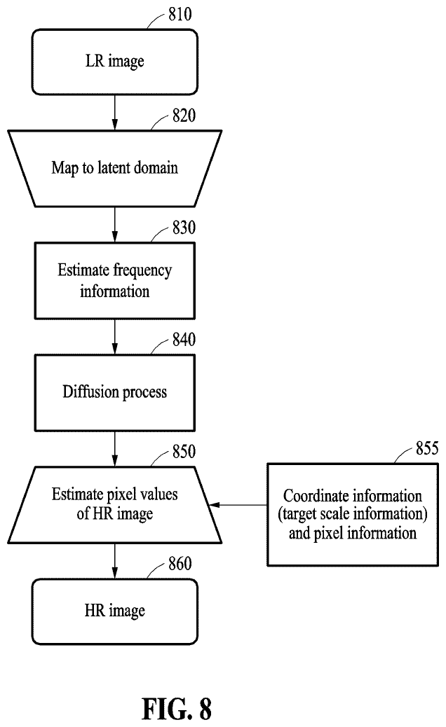

As described in more detail below in an example with reference to FIG. 8, a module that transforms the feature map mapped to the latent domain into a frequency domain may be added to the encoder network for frequency information estimation.

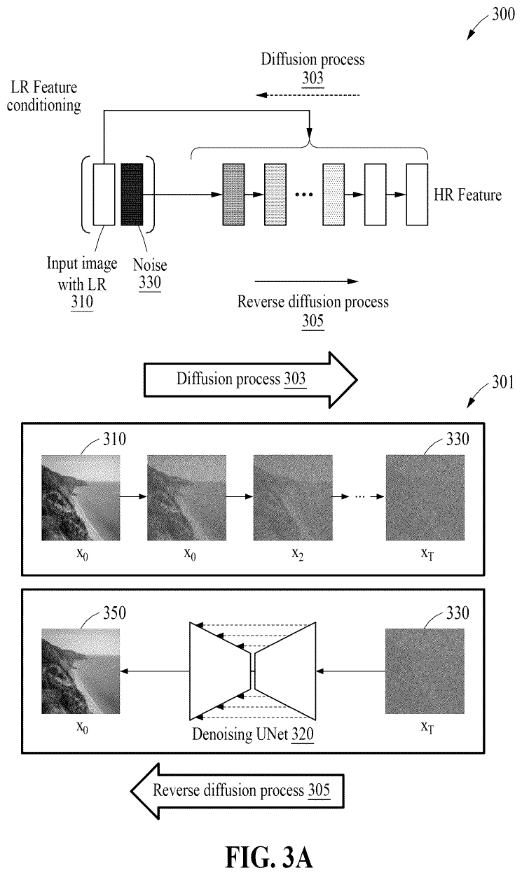

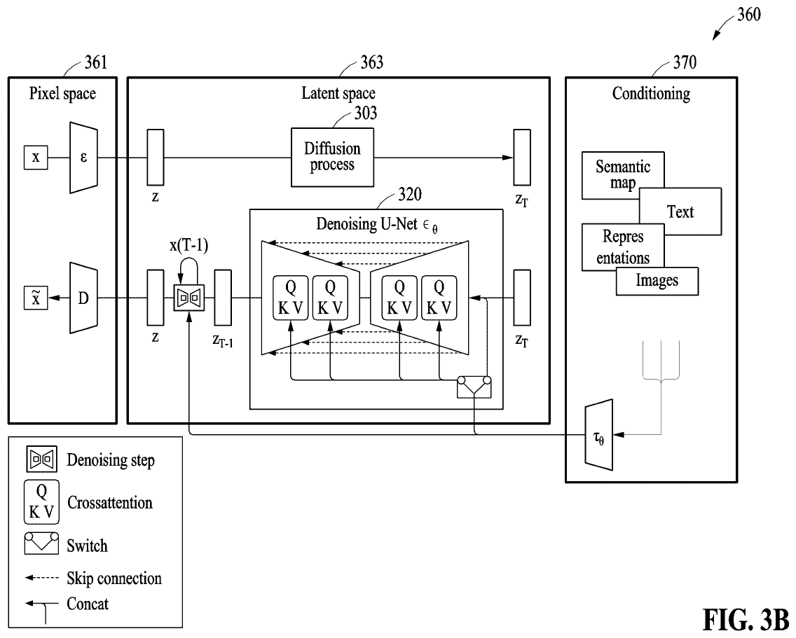

In operation 130, the restoration apparatus may generate, by a diffusion model, an HR feature in which a certain frequency component corresponding to the feature map mapped in operation 120 is restored. Here, the ‘diffusion model’ may correspond to a neural network model that generates a restored image through noise diffusion, that is, an image generation model that generates a restored image of a desired probability distribution from noise through a repetitive operation of a neural network. The diffusion model may perform a diffusion process (e.g., see a diffusion process 303 of FIG. 3A) and a reverse diffusion process (e.g., see a reverse diffusion process 305 of FIG. 3A). The ‘diffusion process’ may correspond to a process of gradually adding noise values according to a fixed normal distribution (e.g., a Gaussian distribution) to pixel values of the feature map. The ‘reverse diffusion process’ may correspond to a process of gradually subtracting noise values generated by a learned normal distribution from the pixel values of the feature map. The diffusion model may output the HR feature in which the certain frequency component corresponding to the feature map is restored, through the reverse diffusion process. The ‘certain frequency component’ may, for example, correspond to a high-frequency component that is higher than a predetermined reference but is not necessarily limited thereto.

The restoration apparatus may restore the certain frequency component corresponding to the feature map by repeatedly performing the reverse diffusion process of the diffusion model by a predetermined number of times. Here, the number of repetitions of the reverse diffusion process may be empirically determined. Examples of a structure and operation of the diffusion model are described in more detail below with reference to FIGS. 3A and 3B.

In operation 130, the restoration apparatus may use various conditions (e.g., conditions 370 of FIG. 3B) to apply a feature (e.g., a feature map) of an LR image to the diffusion model. The conditions may include, for example, the feature of the LR image, the number of repetitions of the diffusion process of the diffusion model, input noise, text, a semantic map, an image-to-image transformation, and/or frequency information but are not necessarily limited thereto.

For example, the restoration apparatus may generate, by the diffusion model, the HR feature in which the certain frequency component (e.g., the high-frequency component) corresponding to the feature map is restored, by concatenating or adding gradually changing input noise with or to the feature map.

In addition, the restoration apparatus may receive the conditions and may extract a scaling factor and a bias factor from the feature map. For example, the restoration apparatus may input the conditions to a linear layer or a convolution layer and may extract the scaling factor and/or the bias factor from the feature map. Since the scaling factor and/or the bias factor may be applied differently for each channel or each position of the feature map, the scaling factor and/or the bias factor may affect factors required for the high-frequency component to be restored. The bias factor may move a predetermined number of positions or center points.

The restoration apparatus may extract the scaling factor and the bias factor, such as “Scale*Norm (Feature)+Bias,” from the feature map by normalization layers according to various normalization techniques. Here, the various normalization techniques may include, for example, any one or more of a group normalization technique, adaptive group normalization (AdaGN) technique, adaptive normalization technique, and/or instance normalization technique but are not necessarily limited thereto. The restoration apparatus may generate the HR feature in which the certain frequency component corresponding to the feature map is restored, by applying the extracted scaling factor and the extracted bias factor to the feature map.

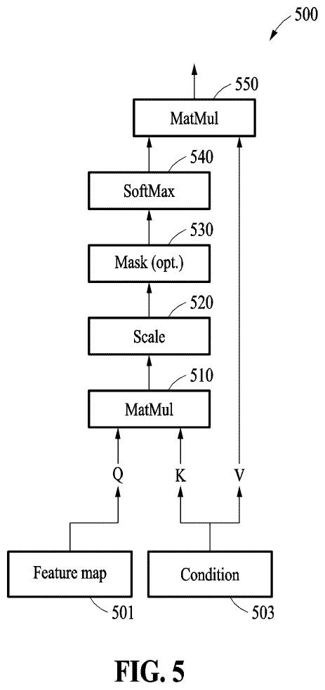

In addition, the restoration apparatus may apply an attention module to the diffusion model. The restoration apparatus may generate the HR feature in which the certain frequency component is restored, using a cross-attention technique that applies, among a query, key, and value, the feature (e.g., the feature map) of the LR image to the query. More specifically, the restoration apparatus may input the feature map to the query according to the cross-attention technique. The restoration apparatus may calculate (e.g., determine) a correlation between the query and the key including matrices of vectors corresponding to the input image in the form of a probability distribution. The restoration apparatus may generate the HR feature in which the certain frequency component corresponding to the feature map is restored, by adding correlation information between the query and a value the value to the feature map by a dot matrix operation between the correlation in the form of a probability distribution and the value of the value according to the cross-attention technique. An example of a method in which the restoration apparatus generates the HR feature in which the certain frequency component corresponding to the feature map is restored, according to the cross-attention technique, is described in more detail below with reference to FIG. 5.

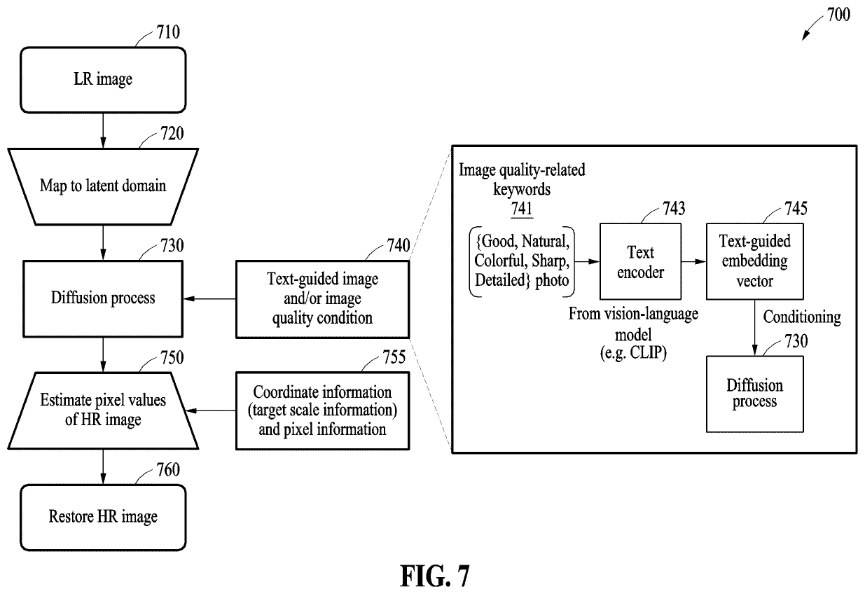

The restoration apparatus may provide, to the diffusion model, text information (e.g., a text feature) as a condition for the diffusion model. The restoration apparatus may generate the HR feature in which the certain frequency component is restored, based on a feature (the ‘text feature’) of image quality-related keywords corresponding to the input image. For example, the restoration apparatus may provide the text information as a condition for image restoration to the diffusion model using a text encoder of a pre-trained visual language model (VLM). An example of a method in which the restoration apparatus generates the HR feature in which the certain frequency component is restored, by applying the text feature to the diffusion model, is described in more detail below with reference to FIG. 7.

In addition, the restoration apparatus may generate the HR feature in which the certain frequency component is restored, based on the frequency information estimated by transforming the feature map mapped to the latent domain into the frequency domain. An example of a method in which the restoration apparatus generates the HR feature in which the certain frequency component is restored, based on the frequency information, is described in more detail below with reference to FIG. 8.

In operation 140, the restoration apparatus may restore an HR image at a target magnification corresponding to the feature map, based on the HR feature generated in operation 130, and coordinate information and pixel information of the HR image at the target magnification among consecutive magnifications. Here, the ‘target magnification’ may correspond to, among the consecutive magnifications, a magnification of an HR image to be restored by the restoration apparatus. For example, the target magnification may be a constant greater than 0 and less than 100 but is not necessarily limited thereto. For example, the target magnification may be received from a user through a user interface (UI) or may be preset to a default value.

In operation 140, the restoration apparatus may estimate pixel values of the HR image at the target magnification including the HR feature, based on the HR feature, and the coordinate information and pixel information of the HR image at the target magnification. The restoration apparatus may estimate, using a decoder network, the pixel values (e.g., red, green, blue (RGB) values) in the HR image at the target magnification including the HR feature from the HR feature, and the coordinate information and pixel information of pixels in the HR image at the target magnification. The coordinate information of pixels in the HR image at the target magnification may be simply expressed as ‘target scale information.’

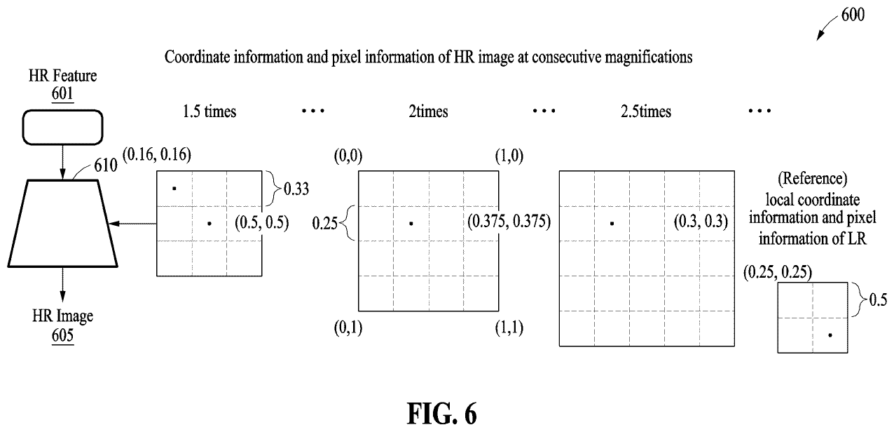

The decoder network may restore the feature map, which is information of the latent domain, to the HR image. The decoder network may be, for example, a network based on multi-layer perceptron but is not necessarily limited thereto. The restoration apparatus may restore the HR image at the target magnification by the estimated pixel values. The decoder network may receive a feature in which high-frequency information passing through the diffusion model is restored, and the coordinate information of pixels in the HR image at a desired target magnification and size information of the pixels and may restore the HR image. An example of a method in which the restoration apparatus restores the HR image at the target magnification is described in more detail below with reference to FIG. 6.

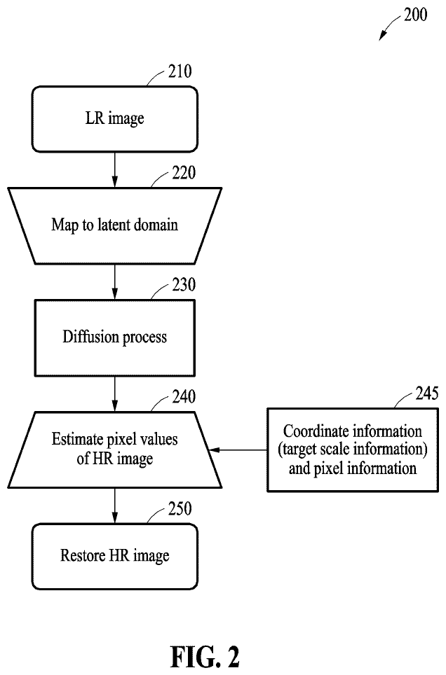

FIG. 2 illustrates an example of a method of restoring an HR image. Referring to FIG. 2, the restoration apparatus may restore the HR image through operations 210 to 250 of a flowchart 200. Operations 210 to 250 described below may be performed in the order and manner as shown and described below with reference to FIG. 2, but the order of one or more of the operations may be changed, one or more of the operations may be omitted, and/or two or more of the operations may be performed in parallel or simultaneously without departing from the spirit and scope of the example embodiments described herein.

In operation 210, the restoration apparatus may receive an LR image as an input image.

In operation 220, the restoration apparatus may map the LR image received from operation 210 to a feature of a latent domain. Here, the restoration apparatus may map a feature of the LR image to the latent domain. For example, the feature of the LR image mapped to the latent domain may have various forms such as a feature vector or feature map. For example, various types of networks, such as a ResNet-based EDSR, SwinIR with a transformer structure, etc., may be used as a network that maps the LR image to the feature map.

In operation 230, the restoration apparatus may perform a diffusion process on the feature (e.g., the feature map) of the LR image mapped to the latent domain in operation 220. The ‘diffusion process’ may correspond to an image generation process by a diffusion model. In the diffusion process, the restoration apparatus may generate an HR feature in which a certain frequency component corresponding to the feature map is restored, by applying the feature map mapped to the latent domain to the diffusion model. The diffusion process may correspond to a process of allowing the feature map representing the feature of the LR image to have the certain frequency component.

The restoration apparatus may apply a diffusion model conditioning the feature (e.g., the feature map) of the LR image to the diffusion process. Here, the ‘diffusion model conditioning the feature of the LR image’ may refer to a diffusion model that assigns a predetermined condition to the feature of the LR image when the HR image is generated, that is, a diffusion model that allows the feature of the LR image to be generated (restored) to the HR image that satisfies the predetermined condition(s). For example, the restoration apparatus may condition the feature of the LR image by concatenating the feature of the LR image with input noise. The diffusion model may, for example, include various types of CNNs, which include a U-Net-based network. In operation 240, the restoration apparatus may estimate pixel values of the HR image using the HR feature in which the certain frequency component generated through the diffusion process in operation 230 is restored, and coordinate information (‘target scale information’) and pixel information 245 of pixels in an HR image at a target magnification. The restoration apparatus may estimate, using a decoder network, pixel values (e.g., RGB values) in the HR image at the target magnification including the HR feature from the HR feature, the coordinate information (the ‘target scale information’) and pixel information 245 of the pixels in the HR image at the target magnification. Here, in addition to the feature map, the coordinate information (the ‘target scale information’) and pixel information 245 of pixels in the HR image at the target magnification may be input to the decoder network. Here, the condition(s) for the HR image at the target magnification to be restored may include, for example, information from coordinate information to the pixel size. Here, the conditions may include positional encoding that performs encoding according to position information (e.g., a positional vector value) in the feature map and a value that passes through a layer to which various transformations are applied. For example, when the coordinate information is input to the decoder network as a condition, the coordinate information may be transformed into a triangular function-based technique called positional encoding and may be provided to the decoder network. In addition to the coordinate information, other pieces of information, such as the pixel size, may be provided as a condition, so the expression, ‘various transformations,’ may be used to mean that a transformation other than positional encoding is applicable. Here, the expression, ‘the value that passes through the layer,’ may refer to a transformed value after passing through a convolutional layer or linear layer.

In operation 250, the restoration apparatus may restore the HR image using the pixel values of the HR image estimated from operation 240.

The method of restoring the HR image may be applied, for example, to a camera requiring a zoom function, a smartphone, medical image equipment, semiconductor image measurement equipment, and/or an autonomous vehicle camera.

FIGS. 3A and 3B illustrate examples of a structure and operation of a diffusion model. FIG. 3A shows diagrams 300 and 301 illustrating the structure and operation of the diffusion model.

An input image 310 with LR and noise 330 having a normal distribution may be input to the diffusion model. The diffusion model may gradually add the noise 330 to the input image 310 with LR (or a feature of the input image 310) over several steps in a diffusion process 303. In the diffusion process 303, the noise 330 generated by a fixed normal distribution may be gradually added to the input image 310 with LR.

The diffusion model may generate a result image 350 having a probability distribution that is similar to the input image 310 with LR by gradually removing the noise 330 in a reverse diffusion process 305 over several steps.

The reverse diffusion process 305 may be a process of generating a sample through a generative model and may also referred to as a ‘sampling’ process. The reverse diffusion process 305 may be performed, for example, by a denoising diffusion probabilistic model (DDPM) or denoising diffusion implicit model (DDIM).

The reverse diffusion process 305 may be performed in a reverse direction of the diffusion process 303. The reverse diffusion process 305 may correspond to a process of removing a noise image generated by a learned normal distribution from an image including the noise 330 to restore (or deformative-generate) the input image 310 with LR through a trained diffusion model. For example, the noise 330 may be noise in a normal distribution form, such as Gaussian noise, but is not necessarily limited thereto.

In the diffusion process 303, the diffusion model may correspond to a deep generation model that restores data by adding the noise 330 to available training data and then removing the noise 330 by performing the reverse diffusion process 305 on the available training data. The diffusion model may gradually train a method of removing the noise 330, and a trained noise removal process, that is, the reverse diffusion process 305, may generate the result image 350 with new high quality from any noise image.

In the diffusion process 303, the diffusion model may make the result image 350, which undergoes the reverse diffusion process 305, have a similar probability distribution to the probability distribution of the input image 310 with LR. For this, in the reverse diffusion process 305, an average and standard deviation, which are probability distribution parameters for noise generation, may be updated, and training may be performed.

The restoration apparatus of one or more embodiments may reduce the computational demand, which occurs when training the diffusion model, to restore (e.g., synthesize) the HR image by allowing the diffusion model to sample less of a corresponding loss term.

The diffusion model of one or more embodiments may use an autoencoding model (e.g., denoising U-Net 320 of FIG. 3B) including a front-end encoder and rear-end decoder, as shown in the diagram 301, such that a space that is the same as an image space 361 and the computational complexity may be reduced. The image space 361 may also be referred to as a ‘pixel space’ in that the image space 361 is a space expressed by pixels.

The restoration apparatus of one or more embodiments may improve, by the autoencoding model, the computational efficiency by performing an operation including sampling in a low-dimensional latent domain (‘a latent domain’) (e.g., a latent space 363 of FIG. 3B) rather than a high-dimensional image space (e.g., the pixel space 361 of FIG. 3B). In addition, the restoration apparatus of one or more embodiments may prevent increasing dispersion in the latent space 363 by performing normalization.

Referring to FIG. 3B, the denoising U-Net 320 of a diffusion model 360 may be a Markov chain that restores an image X₀ by gradually removing Gaussian noise from the noise X_{τ} 330 (e.g., Gaussian noise) of a normal distribution variable. The denoising U-Net 320 is a model designed to train ∇log p(x), which is a data distribution, and may be used, for example, for a reverse process of a fixed Markov chain of length T.

The diffusion model 360 may be interpreted as an equally weighted sequence of the denoising U-Net ϵ_{θ}(xₜ, t) (t=1, . . . , T) 320 trained to predict deformation from which noise of an input xₜ is removed. In addition, T may correspond to the number of repetitions of the diffusion process of the diffusion model 360.

An objective function L_{DM} of the diffusion model 360 may be simply expressed as Equation 1 below, for example.

$${L}_{DM} = {𝔼}_{x , ϵ \sim 𝒩 ( 0 , 1 ) , t} [ {‖ ϵ - {ϵ}_{θ} ( {x}_{t} , t ) ‖}_{2}^{2} ] \qquad Equation 1$$

Here, t may be uniformly sampled at 1, . . . , T. Here, xₜ denotes the input to which noise ϵ is added and may represent a t-th diffusion image among diffusion images from 1 to T. ϵ˜ [symbol] (0,1) denotes that the noise ϵ follows a normal distribution (mean=0, variance=1). ϵ_{θ}(xₜ,t) denotes a denoising network that receives the t-th diffusion image xₜ and a diffusion step t as inputs. [symbol] denotes an expected value in a probability.

Equation 1 may correspond to an equation that calculates the difference between a result estimated by the denoising network (e.g., a denoising autoencoder) and the noise when an image x, noise ϵ, and the diffusion step t are determined.

The feature of the LR image in the pixel space 361 may be mapped to the latent space 363 with a low dimension by forming the diffusion model 360, which is a generation model for a latent representation, using a trained perceptual compression model including an encoder [symbol] and a decoder [symbol] in the pixel space 361.

The denoising U-Net 320 may be formed with two-dimensional (2D) convolutional layers, and the objective function may further focus on the most relevant bits when a reweighted bound is used, as shown in Equation 2 below, for example.

$${L}_{LDM} := {𝔼}_{ε ( x ) , ϵ \sim 𝒩 ( 0 , 1 ) , t} [ {‖ ϵ - {ϵ}_{θ} ( {z}_{t} , t ) ‖}_{2}^{2} ] \qquad Equation 2$$

ϵ_{θ}(⋅,t), which is the backbone of the diffusion model 360, may be implemented, for example, as a time-conditional U-Net. Since the diffusion process 303 is fixed, the restoration apparatus may obtain a latent vector zₜ from the encoder [symbol] during training, and a sample of a data distribution p(z) of a latent vector may pass through the decoder [symbol] once and may be decoded into the image space 361. Here, [symbol] (x) denotes the latent space 363 corresponding to the encoder [symbol] .

Unlike Equation 1, Equation 2 may apply the diffusion process 303 to the latent vector zₜ obtained from the encoder [symbol] rather than the image x. In Equation 2, there may be only a difference in that x is expressed as ε(x) and xₜ is replaced with but the remaining meaning may be provided with reference to the description of Equation 1.

In addition, the diffusion model 360 may model, for example, a conditional distribution of p(z|y) type, like other types of generation models. The conditional distribution may be implemented as a conditional denoising autoencoder ϵ_{θ}(zₜ, t, y). As shown in FIG. 3B, the diffusion model 360 to which the conditional distribution is modeled may control synthesis processes, such as text, a semantic map, and an image-to-image transformation, through an input y corresponding to the conditions 370 and may be concatenated with different types of condition(s).

The diffusion model 360 may allow the diffusion model 360 to generate more flexible conditional images by reinforcing the backbone of the denoising U-Net 320 using the cross-attention technique that is effective in training an attention-based model in various input forms. An example of the cross-attention technique is described in more detail below with reference to FIG. 5.

The restoration apparatus may pre-process various types of the conditions y 370 using an encoder [symbol] for each domain that represents the conditions y 370 as an intermediate representation vector τ_{ϵ}(y)∈ [symbol] and then may map the conditions y 370 to an intermediate layer of the denoising U-Net 320 through a cross-attention layer included in the diffusion model 360. Here, the cross-attention layer may be expressed as Equation 3 below, for example.

The restoration apparatus may train the diffusion model 360, based on the input image 310 with LR and a pair of conditions y 370.

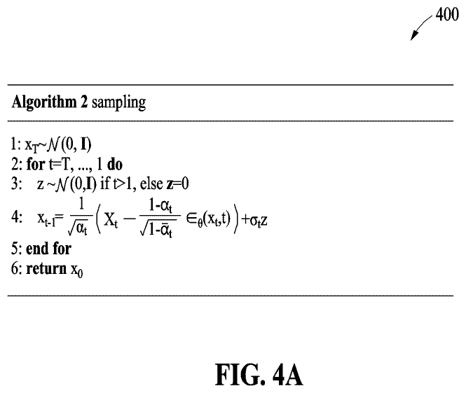

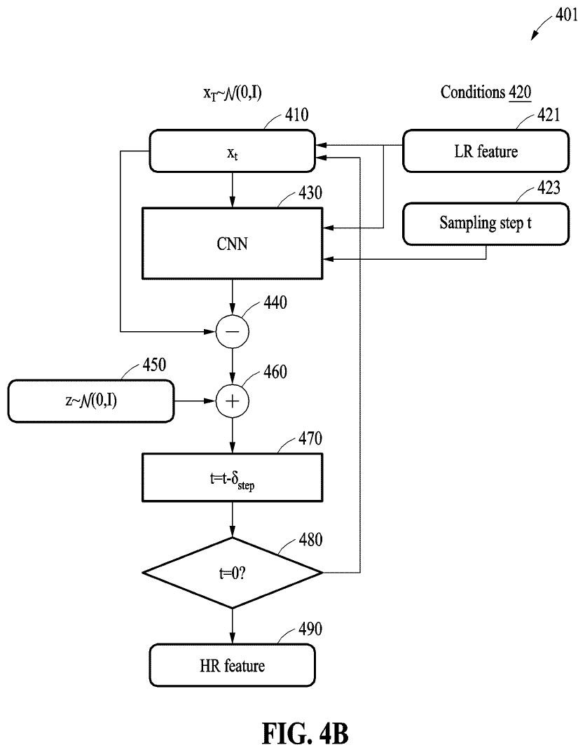

FIGS. 4A and 4B illustrate examples of a process of generating an HR feature in which a certain frequency component is restored, through a reverse diffusion process of a diffusion model. FIG. 4A shows pseudo coding 400 illustrating a process of generating an HR feature in which a certain frequency component is restored. FIG. 4B shows a flowchart 401 illustrating an operation corresponding to the pseudo coding 400.

The restoration apparatus may generate the HR feature in which the certain frequency component is restored, from an LR image, through operations 410 to 490. Operations 410 to 490 described below may be performed in the order and manner as shown and described below with reference to FIG. 4, but the order of one or more of the operations may be changed, one or more of the operations may be omitted, and/or two or more of the operations may be performed in parallel or simultaneously without departing from the spirit and scope of the example embodiments described herein.

In operation 410, the restoration apparatus may receive an image Xₜ of a previous time point including noise X_{τ} (e.g., Gaussian noise) according to a standard normal distribution N (0, 1) (e.g., a Gaussian normal distribution). Here, noise t included in the image Xₜ of the previous X time point may correspond to noise corresponding to t-times among the number of repetitions T of the diffusion process of the diffusion model.

The restoration apparatus may assign conditions 420 to the image Xₜ of the previous time point received from operation 410. The conditions 420 (e.g., the conditions 370 of FIG. 3B) may correspond to constraints that prevent an output value of the diffusion model from deviating from information included in the LR image. The conditions 420 may include, for example, an LR feature 421 and a sampling step t 423 corresponding to the number of repetitions T of the diffusion model but are not necessarily limited thereto. The restoration apparatus may apply the LR feature 421 to operation 410 and/or operation 430. In addition, the restoration apparatus may apply the sampling step t 423 among the number of repetitions T of the diffusion process of the diffusion model to the diffusion model. The restoration apparatus may maintain consistency between the LR image and an HR-restored image generated (restored) by the diffusion model by providing various pieces of information of the LR image as the conditions 420. An example of a method in which the restoration apparatus models the conditions 420 to the diffusion model is described in more detail below with reference to FIG. 5.

In operation 430, the restoration apparatus may input the image Xₜ of the previous time point received from operation 410 to the diffusion model that performs denoising together with the conditions 420. Here, the diffusion model that performs denoising may be, for example, an autoencoder configured with a CNN but is not necessarily limited thereto.

In operation 440, the restoration apparatus may remove noise

$$\frac{1 - {α}_{t}}{\sqrt{1 - {\overline{α}}_{t}}} {ϵ}_{0} ( {X}_{t} , t )$$

output by inputting the image Xₜ of the previous time point to a diffusion model ϵ_{θ} from the image Xₜ of the previous time point. Operation 440 may correspond to

$$( {X}_{t} - \frac{1 - {α}_{t}}{\sqrt{1 - {\overline{α}}_{t}}} {ϵ}_{0} ( {X}_{t} , t ) )$$

in line 4 of the pseudo coding 400. Here, αₜ may correspond to a parameter that adjusts a gradient size.

Operation 440 may correspond to a process of gradually removing Gaussian noise from noise (e.g., Gaussian noise) of a normal distribution variable.

In operation 460, the restoration apparatus may add new noise z 450 to the result of operation 440. Here, the new noise z 450 may correspond to an element for perturbation to an output of the diffusion model. The new noise z 450 may also correspond to noise according to the standard normal distribution N(0, 1) (e.g., the Gaussian normal distribution). Operation 460 may correspond to +σₜz in line 4 of the pseudo coding 400. Here, σₜ may correspond to a parameter that adjusts a gradient size.

In operation 470, the restoration apparatus may calculate the difference between the number of repetitions of the diffusion process of the diffusion model and the number of times δₛₜₑₚ set in the sampling step t 423.

In operation 480, when the difference calculated in operation 470 is 0, that is, when the diffusion model performs a repetition operation by a preset number of repetitions, the restoration apparatus may output an HR feature that is output from the diffusion model in operation 490. In operation 480, when the difference calculated in operation 470 is not 0, that is, when the diffusion model does not perform the repetition operation by a preset number of repetitions, the restoration apparatus may perform operation 410.

FIG. 5 illustrates an example of a method of modeling conditions to a diffusion model. FIG. 5 shows a scaled dot product attention structure 500 according to an attention mechanism.

The attention mechanism may model dependencies between input data and output data regardless of a sequence distance in the input data or the output data.

The scaled dot product attention structure 500 may receive a total of three inputs: a query Q, key K, and value V.

In the scaled dot product attention structure 500, an input may include vectors of the query Q and the key K for a dimension dₖ and vectors of the value V for a dimension dᵥ. The restoration apparatus may calculate a dot product with all keys K, divide each key by a scaling factor, \sqrt{dₖ}, apply a SoftMax function to the result of dividing each key by the scaling factor \sqrt{dₖ}, and obtain a weight of the value V. The queries may be actually packed into a matrix Q, and at the same time, an attention function may be calculated. In addition, the key and the value may be packed into a matrix K and a matrix V, respectively. The matrix Q and the matrix K may have the dimension dₖ, and the matrix V may have the dimension dᵥ. Here, dₖ may be dᵥ (i.e., dₖ=dᵥ).

Here, the query may correspond to a hidden state in a decoder network at a current time point t. The key may correspond to hidden states of the encoder network at any time point. The value may also correspond to hidden states of the encoder network at any time point.

An operation of the scaled dot product attention structure 500 may be expressed as Equation 3 below, for example.

$$Attention ( Q , K , V ) = softmax ( \frac{{QK}^{T}}{\sqrt{{d}_{k}}} ) V \qquad Equation 3$$

Here, Q=W_{Q}⁽ⁱ⁾·ϕᵢ(zₜ), K=W_{K}⁽ⁱ⁾·τ_{θ}(y), and V=W_{V}⁽ⁱ⁾·τ_{θ}(y) Here, ϕᵢ(zₜ)∈ [symbol] may correspond to an intermediate representation vector of U-Net that implements the diffusion model ϵ_{θ}. Here, N denotes a batch size d_{ϵ}ⁱ and denotes the dimension of the intermediate representation vector of U-Net. In addition, τ_{θ}(y) denotes an encoder to which a condition y, such as text or an LR image, is applied.

W_{Q}⁽ⁱ⁾∈ [symbol] , W_{K}⁽ⁱ⁾∈ [symbol] , and W_{V}⁽ⁱ⁾∈ [symbol] may each correspond to a trainable projection matrix. [symbol] denotes that W belongs to a 2D size of real number space of d×d_{τ}.

Here, d_{τ} denotes the dimension of the result of a condition encoder. d_{ϵ}ⁱ denotes the dimension of an intermediate I vector of U-Net ϵ.

Q may correspond to a feature map 501 representing a feature of the LR image, and K and V may correspond to a condition(s) 503 (e.g., the conditions 370 of FIG. 3B and/or the conditions 420 of FIG. 4B) that helps restore a certain frequency component of an HR image. The condition(s) 503 may include, for example, a sampling step representing the number of diffusion repetitions of the diffusion model ϵ_{θ}, the feature of the LR image, a text feature, frequency information, etc. but is not necessarily limited thereto.

According to the scaled dot product attention structure 500, the restoration apparatus may generate a relation vector, such as QK^{T}, by performing a dot product on the feature map 501 and the condition(s) 503 by a MatMul layer 510 that calculates a matrix product of two arrays:

The restoration apparatus may generate a relation matrix through a dot product between a matrix of the feature map 501 corresponding to Q and a matrix of the condition(s) 503 corresponding to K. The attention function may map the query and a key-value pair to an output in which Q, K, V output are all vectors. The attention function may calculate similarities with all ‘keys’ for a given ‘query’ and then reflect the calculated similarities in each ‘value’ mapped to the key. In addition, a value returned by adding up all the ‘values’ in which the similarities are reflected may be an attention value. When the query and the key-value pair are given, the attention value, which is an output corresponding to the query, may correspond to a weighted average value of the value corresponding to each key, using the similarities between the query and the key as a weight. Here, the weight assigned to each value may be calculated by a function associated with the query having a corresponding key.

In the scaled dot product attention structure 500, the restoration apparatus, as an attention function, may use, for example, an additive attention method or a dot product attention method. The additive attention method may calculate a compatibility function using a feed-forward network having a single hidden layer. The additive attention method may correspond to a method of calculating an attention score by concatenating the query with the key and then applying a trainable weight matrix to the query and the key. The additive attention method may correspond to a method of calculating the attention score by applying a trainable weight matrix to the result of concatenating the query with the key after concatenating the query with the key. The dot product attention method may correspond to a method of calculating a similarity using a dot product operation and calculating the attention score based on this.

The restoration apparatus may scale 520 the relation matrix generated through a dot product operation, for example, by

$$\frac{1}{\sqrt{{d}_{k}}} .$$

Here, the addition of the scaling factor

$$\frac{1}{\sqrt{{d}_{k}}}$$

may be performed, for example, to prevent a relation vector QK^{T} from being input to a saturated part in which the gradient becomes extremely small in the SoftMax function as the dot product size increases when the value of dₖ is large.

The restoration apparatus may of one or more embodiments may improve training performance by making all values similar to ‘0’ by the scaling 520 of the relation matrix.

The restoration apparatus may prevent features that do not want to be referenced from being reflected in the relation matrix by masking a correlation with features that do not want to be referenced in the relation matrix, through a mask layer 530. The mask layer 530 may be optionally used.

The restoration apparatus may calculate a correlation (or a similarity) between features of the feature map 501 and the condition(s) 503 in the form of a probability distribution, through a SoftMax layer 540. The SoftMax layer 540 may be for normalizing the correlation (the similarity) to a value between, for example, 0 to 1.

The restoration apparatus may generate a vector in which correlation information between Q and K is added to the feature map 501 by performing a dot product operation between the correlation in the form of a probability distribution and data value V by a MatMul layer 550.

FIG. 6 illustrates an example of a method of restoring an HR image at a target magnification. FIG. 6 shows a diagram 600 illustrating a method of restoring an HR image at a target magnification.

For example, when a target magnification (1.5 times) is selected by a user among consecutive magnifications, such as 1.5 times, 2 times, 2.5 times, etc., the restoration apparatus may estimate pixel values of the HR image at the target magnification including an HR feature by inputting coordinate information (e.g., a local coordinate (0.16, 0.16)) of the HR image at the target magnification (1.5 times) to a neural network 610 (e.g., a decoder network) together with an HR feature 601. Here, information, such as the size of pixels of the HR image, may also be provided to the neural network 610.

The restoration apparatus may restore an HR image 605 at the target magnification by the estimated pixel values. Here, the neural network 610 may correspond to a network that receives the HR feature 601 in which a certain frequency component is restored, and restores the HR feature 601 to the HR image 605. The neural network 610 may be, for example, multi-layer perceptron formed with a fully-connected layer and an activation layer or various types of CNNs but is not necessarily limited thereto. The restoration apparatus may restore the HR image 605 at a consecutive magnification by the diffusion process described above.

FIG. 7 illustrates an example of a method of restoring an HR image in which a certain frequency component is restored, based on a text feature. FIG. 7 shows a diagram 700 illustrating a method of generating an HR feature in which a certain frequency component is restored, by applying a text feature based on image quality-related keywords to a diffusion model.

A network structure (e.g., a text encoder 743) that generates conditions guiding a user to a desired direction of image quality by the image quality-related keyword(s) may be additionally applied to the diffusion model. The text encoder 743 may map the image quality-related keyword(s) to an embedding vector corresponding to a related image. Here, the text encoder 743 may retrieve a common embedding vector between text and an image from the VLM.

The restoration apparatus may generate the HR feature in which the certain frequency component is restored, through operations 710 to 760.

In operation 710, the restoration apparatus may receive an LR image as an input image.

In operation 720, the restoration apparatus may map the LR image received from operation 710 to a feature of a latent domain. Here, the restoration apparatus may map a feature of the LR image to the latent domain.

In operation 730, the restoration apparatus may perform a diffusion process on the feature (e.g., the feature map) of the LR image mapped to the latent domain in operation 720. The restoration apparatus may apply the diffusion model conditioning the feature (e.g., the feature map) of the LR image to the diffusion process. Here, the ‘diffusion model conditioning the feature of the LR image’ may refer to a diffusion model that assigns a predetermined condition to the feature of the LR image when the HR image is generated, that is, a diffusion model that allows the feature of the LR image to be generated (restored) to the HR image that satisfies the predetermined condition.

In the diffusion process of operation 730, the restoration apparatus may generate the HR feature in which the certain frequency component corresponding to the feature map, and a text-guided image and/or image quality condition 740 is restored, by applying the feature map mapped to the latent domain to the diffusion model together with the text-guided image and/or image quality condition 740. Here, an example of a process of obtaining the text-guided image and/or image quality condition 740 is described below.

In operation 741, the restoration apparatus may receive the image quality-related keywords corresponding to the input image. The image quality-related keywords may be, for example, keywords associated with brightness, colorfulness, sharpness, and/or noise corresponding to the input image, such as {good, natural, colorful, vivid, enriched, etc.} but are not necessarily limited thereto.

In operation 745, the restoration apparatus may map the image quality-related keyword(s) to the embedding vector corresponding to a related image using the text encoder 743. That is, the restoration apparatus may extract a text feature (e.g., a ‘text-guided embedding vector’) corresponding to the image quality-related keywords. The restoration apparatus may allow, by the text feature, the subjective image quality preference of a user to be reflected when restoring the HR feature. For example, the restoration apparatus may extract the text feature corresponding to the image quality-related keywords using the text encoder 743 based on a pre-trained VLM. Here, the VLM may model a correlation between the feature of the input image and the text feature corresponding to the input image to one embedding space shared by the input image and the text corresponding to the input image. More specifically, when an image or text is input to the VLM, the VLM may predict an image corresponding to the text without training, by expressing each element of the image or text as a feature vector of one embedding space shared by the input image and text. The text encoder 743 may express (encode) the image quality-related keywords as text feature vectors in one embedding space.

In operation 750, the restoration apparatus may estimate pixel values of the HR image using the HR feature in which the certain frequency component generated through the diffusion process in operation 730 is restored, and coordinate information (e.g., target scale information) and pixel information 755 of pixels of an HR image at a target magnification. For example, the restoration apparatus may estimate, using a decoder network, pixel values (e.g., RGB values) in the HR image at the target magnification including the HR feature from the HR feature, and the coordinate information (e.g., target scale information) and pixel information 755 of pixels in the HR image at the target magnification. Here, in addition to the feature map, the coordinate information (e.g., target scale information) and pixel information 755 of the pixels in the HR image at the target magnification may be input to the decoder network. Here, condition(s) for the HR image at the target magnification to be restored may include, for example, information such as the coordinate information and pixel size. Here, the application of various transformations, such as positional encoding that performs encoding according to position information (e.g., a positional vector value) in the feature map and a value that passes through a layer may be included in the conditions, but examples are not necessarily limited thereto. In operation 760, the restoration apparatus may restore the HR image using the pixel values of the HR image estimated from operation 750.

FIG. 8 illustrates an example of a method of restoring an HR image based on estimated frequency information. Referring to FIG. 8, the restoration apparatus may restore an HR feature through operations 810 to 860. Operations 810 to 860 described below may be performed in the order and manner as shown and described below with reference to FIG. 8, but the order of one or more of the operations may be changed, one or more of the operations may be omitted, and/or two or more of the operations may be performed in parallel or simultaneously without departing from the spirit and scope of the example embodiments described herein.

In operation 810, the restoration apparatus may receive an LR image.

In operation 820, the restoration apparatus may map the LR image to a feature map of a latent domain.

In operation 830, the restoration apparatus may estimate frequency information from the feature map mapped to the latent domain. The restoration apparatus may estimate, for example, the frequency information from the feature map using a fast Fourier transform (FFT) technique and/or a local texture estimation (LTE) technique for an implicit expression function but is not necessarily limited thereto.

The FFT technique may correspond to a technique that transforms a discrete signal into a frequency domain.

The LTE technique for an implicit expression function may include two trainable convolutional layers and one fully-connected layer and may correspond to a technique of estimating a frequency domain value after summing result values that pass through corresponding layers through a trigonometric function.

The restoration apparatus may extract Fourier information (e.g., a Fourier coefficient) from the LR image and may transmit the Fourier information to an implicit expression neural network, according to the LTE technique for an implicit expression function. For a temporal implicit neural network, the Fourier information may help estimate a certain frequency component. The LTE technique for an implicit expression function directly extracts the frequency of an image, so the LTE technique may be useful for restoring a high frequency in terms of the image quality restoration. The restoration apparatus of one or more embodiments may improve image quality by restoring the high frequency.

The method of improving image quality described above may be used, for example, in an image or photo-related product such as a CCTV, display, camera, etc.

In operation 840, the restoration apparatus may generate the HR feature in which the certain frequency component corresponding to the feature map is restored, by applying the frequency information to a diffusion model in a diffusion process. The diffusion process may also be applied to a domain in which the frequency component is estimated from a feature map of LR. To generate and restore the certain frequency component, the restoration apparatus may allow the HR feature, generated by applying the feature map to the diffusion model after transforming the feature map into the frequency domain, to focus more on the frequency information.

In operation 850, the restoration apparatus may estimate pixel values of the HR image using the HR feature in which the certain frequency component generated through the diffusion process in operation 840 is restored, and coordinate information (e.g., target scale information) and pixel information 855 of pixels in an HR image at a target magnification. For example, the restoration apparatus may estimate, using a decoder network, pixel values (e.g., RGB values) in the HR image at the target magnification including the HR feature from the HR feature, and the coordinate information (e.g., target scale information) and pixel information 855 of the pixels in the HR image at the target magnification.

In operation 860, the restoration apparatus may restore the HR image using the pixel values in the HR image estimated from operation 850.

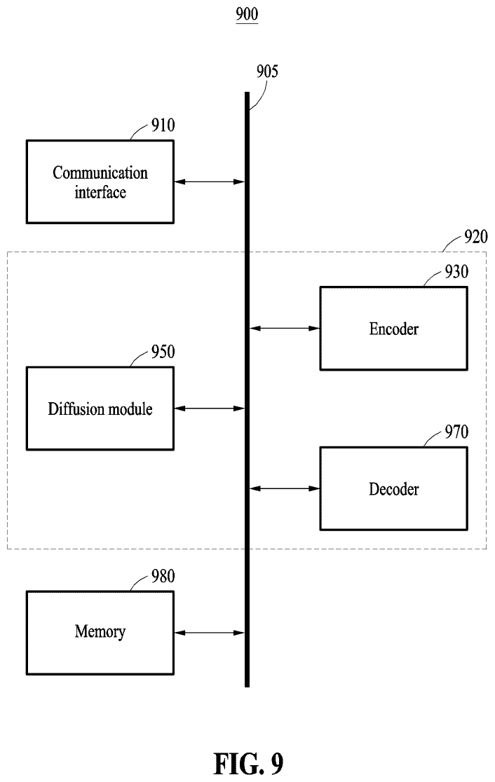

FIG. 9 illustrates an example of an apparatus for restoring an HR image. Referring to FIG. 9, a restoration apparatus 900 may include a communication interface 910, a processor 920 (e.g., one or more processors), and a memory 980 (e.g., one or more memories). The communication interface 910, the processor 920, and the memory 980 may be connected to each other via a communication bus 905.

The communication interface 910 may receive an input image with LR.

The processor 920 may include at least one of an encoder 930 including an encoding network, a diffusion module 950 including a diffusion model, and/or a decoder 970 including a decoder network. The processor 920 may be one processor or a plurality of processors.

The encoder 930 may, using the encoding network, map the input image received from the communication interface 910 to a feature map of a latent domain.

The diffusion module 950 may, using the diffusion model, generate an HR feature in which a certain frequency component corresponding to the feature map mapped to the latent domain is restored, by the encoder 930.

The decoder 970 may, using the decoder network, restore an HR image at a target magnification corresponding to the feature map, based on the HR feature generated by the diffusion module 950, and coordinate information and pixel information of the HR image at the target magnification among consecutive magnifications. Here, the target magnification may be received from a user through a UI or may be preset as a default value.

The encoder 930 and the decoder 970 may be configured by the processor 920, and the diffusion module 950 may be stored in the memory 980 or a cloud server (not shown).

The memory 980 may store a variety of information generated during the processing process of the processor 920 described above. In addition, the memory 980 may store various types of data and programs. The memory 980 may include a volatile memory or a non-volatile memory. The memory 980 may include a high-capacity storage medium such as a hard disk to store a variety of data.

In addition, the processor 920 may perform the methods described with reference to FIGS. 1 to 8 and an algorithm corresponding to the methods.

The processor 920 may execute a program and control the restoration apparatus 900. Code of the program executed by the processor 920 may be stored in the memory 980. For example, the memory 980 may include a non-transitory computer-readable storage medium storing instructions that, when executed by the processor 920, configure the processor 920 to perform any one, any combination, or all of operations and methods of FIGS. 1-8.

The restoration apparatuses, communication interfaces, processors, encoders, diffusion modules, decoders, memories, communication buses, restoration apparatus 900, communication interface 910, processor 920, encoder 930, diffusion module 950, decoder 970, memory 980, and communication bus 905, described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-9 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method with high-resolution (HR) image restoration, the method comprising:
mapping an input image with low resolution (LR) to a feature map of a latent domain;
generating, using a diffusion model, an HR feature in which a certain frequency component corresponding to the feature map is restored; and
based on the HR feature and coordinate information and pixel information of an HR image at a target magnification, restoring the HR image at the target magnification corresponding to the feature map.

2. The method of claim 1, wherein the mapping of the input image to the feature map of the latent domain comprises mapping the input image to the feature map of the latent domain using an encoder network.

3. The method of claim 1, wherein the diffusion model is configured to perform:
a reverse diffusion process that gradually subtracts noise values generated by a learned normal distribution from pixel values of the feature map; and
a diffusion process that gradually adds noise values according to a fixed normal distribution to the pixel values of the feature map.

4. The method of claim 3, wherein the generating of the HR feature comprises restoring the certain frequency component corresponding to the feature map by repeatedly performing the reverse diffusion process of the diffusion model by a predetermined number of times.

5. The method of claim 1, wherein the generating of the HR feature comprises generating, using the diffusion model, the HR feature in which the certain frequency component corresponding to the feature map is restored, by concatenating or adding gradually changing input noise with or to the feature map.

6. The method of claim 1, wherein the generating of the HR feature comprises:
extracting a scaling factor and a bias factor from the feature map using a normalization technique; and
generating the HR feature in which the certain frequency component corresponding to the feature map is restored, by applying the scaling factor and the bias factor to the feature map.

7. The method of claim 6, wherein the normalization technique comprises one of a group normalization technique, an adaptive group normalization (AdaGN) technique, and an instance normalization technique.

8. The method of claim 1, wherein the generating of the HR feature comprises generating the HR feature in which the certain frequency component corresponding to the feature map is restored, by applying the feature map to a cross-attention technique.

9. The method of claim 1, wherein the generating of the HR feature comprises:
receiving image quality-related keywords corresponding to the input image;
extracting a text feature corresponding to the image quality-related keywords; and
generating the HR feature in which the certain frequency component corresponding to the feature map is restored, by mapping the text feature to the feature map.

10. The method of claim 9, wherein the extracting of the text feature comprises extracting the text feature corresponding to the image quality-related keywords using a text encoder based on a pre-trained vision language model (VLM).

11. The method of claim 1, wherein
the mapping of the input image to the feature map of the latent domain further comprises estimating frequency information from the feature map, and
the generating of the HR feature comprises generating the HR feature in which the certain frequency component corresponding to the feature map is restored, by applying the frequency information to the diffusion model.

12. The method of claim 11, wherein the estimating of the frequency information comprises estimating the frequency information from the feature map using either one or both of a fast Fourier transform (FFT) technique and a local texture estimation (LTE) technique for an implicit expression function.

13. The method of claim 1, wherein the restoring of the HR image comprises:
estimating pixel values of the HR image at the target magnification comprising the HR feature, based on the HR feature, and the coordinate information and the pixel information of the HR image at the target magnification; and
restoring the HR image at the target magnification by the estimated pixel values.

14. The method of claim 13, wherein the estimating of the pixel values of the HR image at the target magnification comprises estimating the pixel values of the HR image at the target magnification comprising the HR feature, from the HR feature, and the coordinate information and the pixel information of the HR image at the target magnification, using a decoder network.

15. The method of claim 14, wherein the decoder network comprises a network based on multi-layer perceptron.

16. A non-transitory computer-readable storage medium storing instructions that, when executed by one or more processors, configure the one or more processors to perform the method of claim 1.

17. An apparatus with high-resolution (HR) image restoration, the apparatus comprising:
one or more processors configured to:
map, using an encoder network, an input image with low resolution (LR) to a feature map of a latent domain;
generate, using a diffusion model, an HR feature in which a certain frequency component corresponding to the feature map is restored; and
based on the HR feature and coordinate information and pixel information of an HR image at a target magnification, restore, using a decoder network, the HR image at the target magnification corresponding to the feature map.

18. The apparatus of claim 17, wherein, for the generating of the HR feature, the one or more processors are configured to generate, using the diffusion model, the HR feature in which the certain frequency component corresponding to the feature map is restored, by concatenating gradually changing input noise with the feature map.

19. The apparatus of claim 17, wherein
the one or more processors are configured to:
extract, using a text encoder based on a pre-trained vision language model (VLM), extract a text feature corresponding to image quality-related keywords corresponding to the input image; and
for the generating of the HR feature, generate, using the diffusion model, the HR feature in which the certain frequency component corresponding to the feature map is restored, by mapping the text feature to the feature map.

20. The apparatus of claim 17, wherein the apparatus is any one or any combination of any two or more of a smartphone, a camera, a closed-circuit television (CCTV), medical image equipment, semiconductor measurement equipment, an autonomous vehicle camera, a mixed reality (MR) device, and an augmented reality (AR) device.
